(19) United States
(12) Patent Application Publication
(10) Pub. No.: US 2012/0310848 A1
(43) Pub. Date: Dec. 6, 2012

(54) ANTI-COUNTERFEITING MARKING WITH ASYMMETRICAL CONCEALMENT

(76) Inventors: ZeMing M. Gao, Portland, OR (US); Pingyi Yan, Shenzhen (CN)

(21) Appl. No.: 13/118,605

(22) Filed: May 31, 2011

(51) Int. Cl. G06Q 99/00; G06K 5/00; G06K 19/07

(52) U.S. Cl. 705/317; 235/492; 235/380

(57) ABSTRACT

An anti-counterfeiting method associates the first code with an article to be authenticated to identify the article, and associates a second code with the first code as a verification code to verify the first code. Both the first code and the second code are reproduced on the article. The reproduced first code is machine-readable (e.g., contained in a RFID tag), while the reproduced second code is covert and concealed from normal viewing by a concealment means such as a scratch-off material. An authorized person (e.g., a consumer) is allowed to conditionally remove the concealment to reveal the covert code. The first code and the revealed second code are used to verify the authenticity of the product with a verification center. During the verification, the first code identifies the article, while the second code verifies the first code and thus the authenticity of the associated article.

### BACKGROUND

Product counterfeiting is a large and ever worsening problem in today's world economy. Not only does counterfeiting cause hundreds of billion dollars of losses, it also poses a threat to the life quality and the life safety of consumers.

Many anti-counterfeiting methods have been used and proposed in the past and the present, including both legal/social solutions and technological solutions. Technological solutions range from holograms, mass serialization, RFID, and chemical and physical analytical tests. Of the available solutions, some do not offer effective anti-counterfeiting while others are too complicated and costly.

For example, mass serialization requires a unique identifier for each individual product item sold or delivered to consumers. The unique product identifier may be used to check the authenticity of the corresponding product item. This requires a massive effort at the system level and requires a broad standard to be established and enforced. In addition, although mass serialization may be effective on discouraging mass counterfeiting which makes identical product items with identical markings or labeling, it is not effective on making counterfeit products which bear verifiable product identifiers on each item. This is because with product identifiers on the genuine products easily readable, it isn't prohibitively difficult to gain access to product identifiers, even a large number of them, for use on counterfeit products.

To alleviate the above problem, one proposal is to conceal the product identifier using a scratch-off material, and let the consumer remove the scratch-off when purchasing the product in order to use the uncovered product identifier to verify the authenticity of the product. This method, however, has its own disadvantages. For example, the method requires the consumer to remove a large area of scratch-off material for each item purchased, causing an unpleasant consumer experience. The problem is especially prominent when a long product identifier is used to achieve a necessary level of identification, or a 2-D code is needed for product identification.

There is a need to develop better and more practical and convenient anti-counterfeiting methods.

### SUMMARY OF THE INVENTION

This patent application discloses an anti-counterfeiting method which takes advantage of a previously unrealized asymmetric nature between the information that needs to be concealed to effectively discourage counterfeiting and the information required for sufficiently identify an article such as a product. Specifically, the amount of information that needs to be concealed to effectively discourage counterfeiting can be far less than the amount of information that is required to sufficiently identify an article. As a result, it is unnecessary to treat the two types of the information as the same information and conceal the entire information in order to effectively prevent counterfeiting. Alternatively, it is possible to have two different codes of asymmetric sizes and/or different types, one large and one small, one machine-readable and one covert, and used in combination for product identification and anti-counterfeiting respectively.

Two separate codes can be used in combination for this purpose, of which the first code is a machine-readable code, such as a code contained in a RFID tag, and the second code is a covert code readable only with an invasive method. In one embodiment, the first code alone is sufficient for identifying the article to be authenticated. The second code (the covert code) is only long enough to discourage counterfeiting but does not have to contain enough information to identify the product by itself. For the purpose of authenticity verification, the first code is used to identify the article, while the second code is used to verify the first code, and thus the article identified by the first code.

In one embodiment, the method associates the first code with the article, and associates the second code with the first code as a verification code to verify the first code. Both the first code and the second code are reproduced on the article to be authenticated. The first code is machine-readable (e.g., contained in a RFID tag attached to the article). The concealment of the second code is done in a way to allow an authorized person to uncover the concealed second code on or in the article to completely reveal the second code. The removing of the concealment is invasive enough to leave a sign indicating that the concealment has been removed. In verification, the verification center receives the first code, identifies the second code associated with the received first code. The authenticity of the article is verified by matching the identified second code with the second code conditionally revealed from the article to the authorized prison.

In one embodiment, an authorized person such as a consumer to whom the second code has been revealed sends the first code and the second code to a verification center, which compares the received first code and second code with article code records stored in the data storage, and verifies to the authorized person that the product is authentic if the received first code and second code find a match in the article code records stored in the data storage.

The communication between the authorized person and the verification center may be carried out in a variety of ways, including a telephone by voice, a telephone to dial in numbers, a wireless phone using short messaging, an application on a computer, a mobile application platform, and Internet-based user interface. An application program run on a computer or a mobile phone may have a preconfigured connection with a verification center, and once initiated, does not require the consumer to enter a phone number or URL address to connect to the verification center.

In another embodiment, the verification center receives the first code only but not the second code. Upon receiving the first code, the verification center checks against the product code records saved in the data storage to identify the code record associated with the product identified by the first code. The verification center then sends the second code associated with the identified first code back to the authorized person, who then checks the received second code against the second code revealed on or in the product to determine if the two codes match.

A would-be counterfeiter cannot easily remove the concealment to reveal second code without damaging the intact status of the code on the product. As a result, the only way to counterfeit the product code is to guess the concealed second code. If the counterfeiter makes a counterfeit product bearing such a guessed code, the counterfeit product runs the risk of being detected and rejected in the market. The guessing is thus not merely a costless intellectual act, but a costly endeavor to be practiced.

On the other hand, it is discovered that even a very small covert code can have a meaningful anti-counterfeiting effect. An advantage of having a relatively small covert code is that it does not cause a significant inconvenience for authorized persons to reveal the covert code. For example, a mere two-digit code would have one hundred possibilities. A counterfeit product bearing a randomly guessed two-digit code would only have a 1% of a chance to have the correct code and a 99% of a chance to have a wrong one. If the counterfeiter is to make a hundred counterfeiter products to statistically guarantee one success, he runs the risk of having ninety nine out of the hundred detected as a counterfeit and rejected in the market. This creates a large penalty factor and causes a heavy burden on the counterfeiter, and turns the economics against the counterfeiter, while at the same time does not create a heavy burden on the authorized persons.

Furthermore, multiple concealed codes may be used to offer multiple opportunities to verify the authenticity of the product. For example, two separate covert codes may give two separate opportunities of verification, one used by the original purchaser at the retailer, the other by the recipient of the product as a gift from the original purchaser at another occasion.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### DESCRIPTION OF DRAWINGS

The detailed description is described with reference to the accompanying figures. In the figures, the left-most digit(s) of a reference number identifies the figure in which the reference number first appears. The use of the reference numbers which are identical except for the leading figure digit(s) in different figures indicates similar or identical items.

FIG. 1 shows a flow process of the first exemplary embodiment of the anti-counterfeiting method in accordance with the present disclosure.

FIGS. 2A-2B show a first exemplary set of anticounterfeiting codes used in the first exemplary embodiment of the anti-counterfeiting method.

FIGS. 3A-3B show the first exemplary set anticounterfeiting codes as reproduced on the product and used for authentication of the product according to the first exemplary embodiment of the anti-counterfeiting method.

FIG. 4 shows a flow process of the second exemplary embodiment of the anti-counterfeiting method.

FIGS. 4A-4D show a second exemplary set of anticounterfeiting codes having multiple covert codes used in the second exemplary embodiment of the anti-counterfeiting method.

FIGS. 5A-5C show an exemplary anticounterfeiting code using a mix of a barcode and an alphanumerical code.

### DETAILED DESCRIPTION

The anti-counterfeiting method is disclosed in further detail below using several exemplary embodiments with reference to various figures. In this description, the order in which a process is described is not intended to be construed as a limitation, and any number of the described process blocks may be combined in any order to implement the method, or an alternate method.

A typical anti-counterfeiting process involves a manufacturer, a retailer and a consumer, and possibly also other parties such as a shipping company and a distributor. However, anti-counterfeiting process may also involve a non-retailing process, such as a banking or government transaction involving documents, bills or checks that need to be authenticated. In the exemplary embodiments of this detailed description, a product is described as the object of authentication by a buyer or consumer. Such description is not meant to be restrictive but only illustrative. The product can be any article that needs to be authenticated, while the consumer may be any user or authorized person that desires the authentication of the article. In addition, although in the exemplary processes of this description a manufacturer acts to exercise the anti-counterfeiting method, it is understood that another party such as an anti-counterfeiting service provider may be an actor to exercise the anti-counterfeiting method.

Disclosed herein is an anti-counterfeiting method which, in one embodiment, is carried out according to the following procedure. The manufacturer assigns a product code to a product and stores the product code in a data storage. The product code has two separate codes. The first code is a product identification code which identifies the product, and the second code is a verification code which is associated with the product identification code to verify the product identification code, much like a passcode or confirmation code that verifies an account number such as a credit card number or debit card number. The manufacturer reproduces the product code on the product in a hybrid fashion such that the reproduced product identification code is machine-readable (e.g., contained in a RFID tag attached to the product), and the reproduced verification code is a covert code which can be revealed only invasively. An authenticity verification center receives the machine-readable product identification code, and identifies the second code associated with the received first code. Authenticity of the article is verified by matching the identified second code with the second code conditionally revealed from the article. As well be illustrative hearing, the revealed second code may be sent to the authenticity verification center which then compares it with the identified second code for verification; but alternatively, the identified second code may be sent from the authenticity verification center to an authorized person (e.g., a consumer) who then compares it with the revealed second code for verification.

According to the disclosed method, as long as the covert code cannot be easily reproduced on another product by an unauthorized party, the above method will have an anti-counterfeiting effect.

There may be various ways to make the covert code difficult to be reproduced on another product by an unauthorized party. One method is to block the covert code from normal viewing and require an invasive act to gain access to the blocked covert code. If the invasive act causes sufficient damages which cannot be easily restored, it would render the product that had the original product code unsellable. This way, even if the unauthorized party may be able to reproduce the product code on a counterfeit product, the act has rendered the original product unsellable, at least causing a significant economic burden, and perhaps even defeating the purpose of counterfeiting itself.

A second method is to encrypt the covert code reproduced (e.g., printed) on a medium. The encryption is done in a way so that the covert code may be decrypted using a cipher, but the covert code itself cannot be easily reproduced again on another product by an unauthorized party even if the unauthorized party has access to the original product itself.

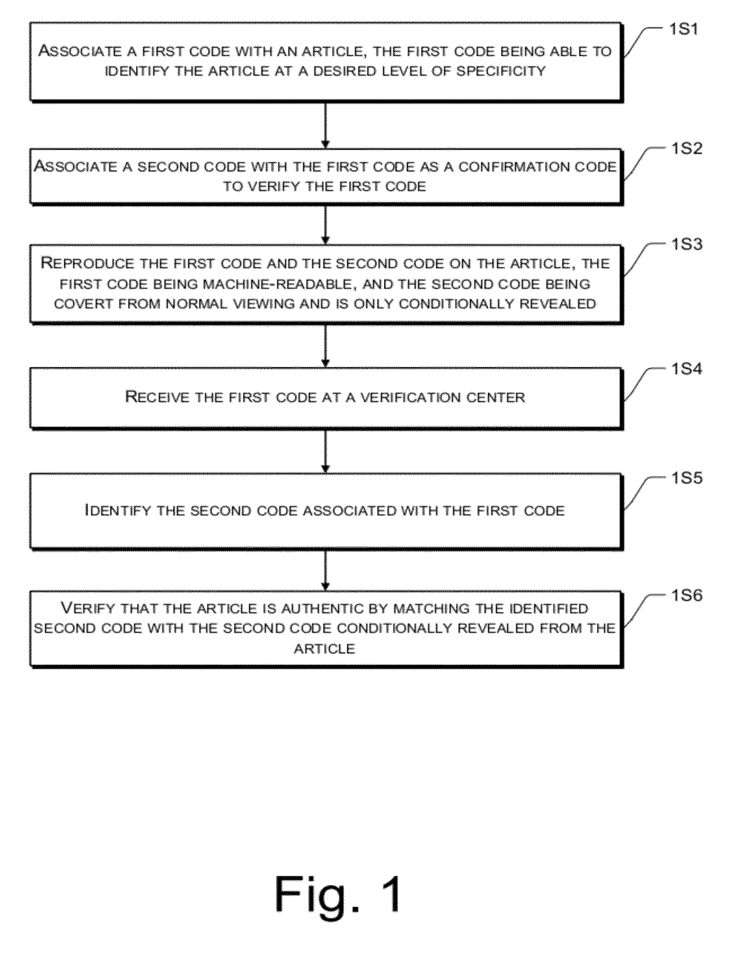

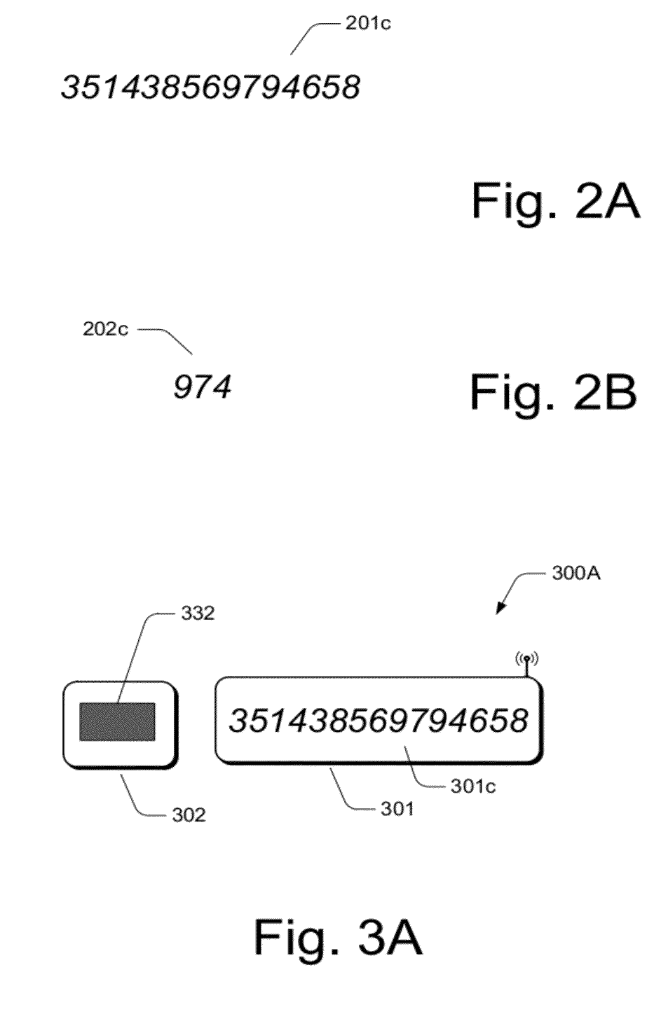

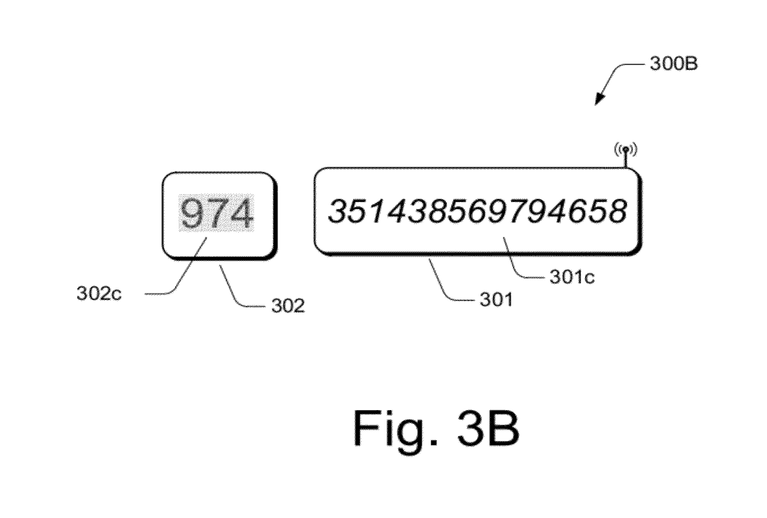

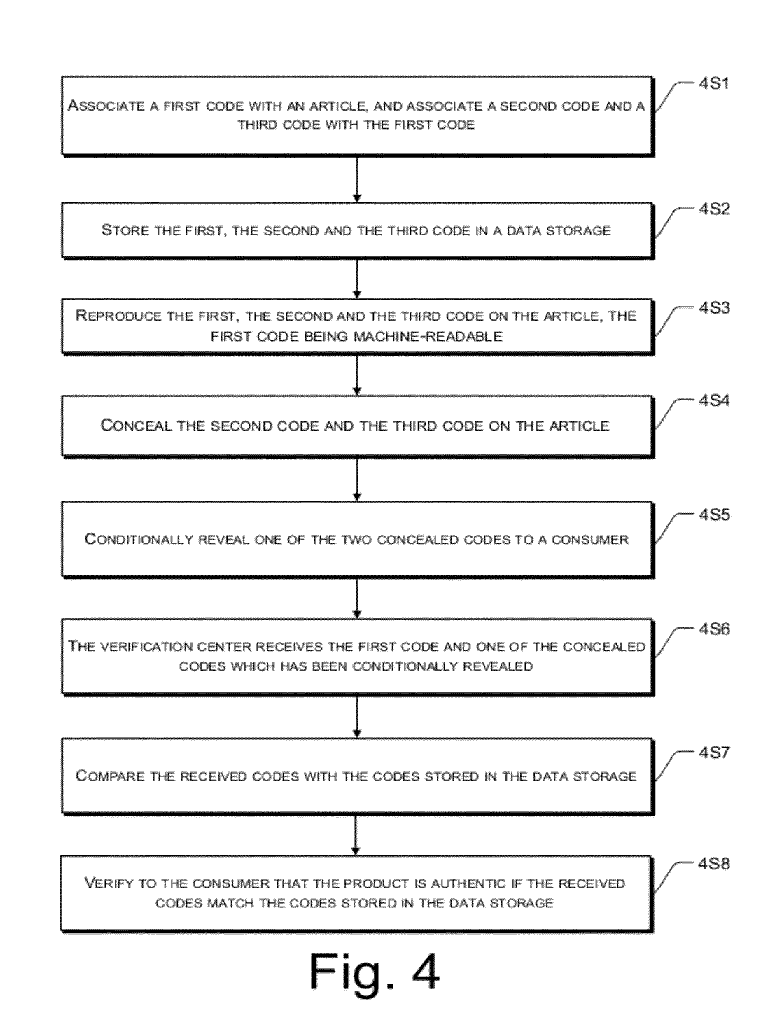

A first exemplary embodiment of the disclosed anti-counterfeiting method is illustrated in reference to FIG. 1 and FIGS. 2A, 2B, FIGS. 3A and 3B. FIG. 1 shows a flow process of the first exemplary embodiment of the anti-counterfeiting method.

At Block 1S1, the manufacturer assigns a first code to a product. This involves associating a product-identifying code with the product. The product code can be any type of a code that is sufficient to identify the product. Different manufacturers may need various levels of product identification. At a very low level, the product code may only be able to identify a certain product type or model. But in order to offer sufficiently effective anti-counterfeiting, higher level of specificity of the product identification is preferred. For example, the product code preferably uniquely identifies a production batch of the same product, and more preferably uniquely identifies a package of the same product, and still more preferably uniquely identifies each separate product as an individual item. If the manufacturer, or the anti-counterfeiting service provider, participates in a standard body for mass serialization, the product code assigned may not only be product-specific among other products of the same manufacture or the same industry, but also be product-specific among all products in the commerce that participate in the mass serialization standard.

At Block 1S2, the manufacturer associates a second code with the first code as a verification code to verify the first code. The second code is added as a verification code to discourage counterfeiting in association with the product-identifying first code. More specifically, the first code is created as a product-identifying code and associated with a product to identify the product, while the second code is generated separately and assigned to the first code as a verification code in association with the first code.

FIG. 2A and FIG. 2B show an exemplary first code and an exemplary second code, respectively, used in accordance with the present disclosure. The first code 201c and the second code 202c are each a plain numerical code in the illustrated embodiment. In one embodiment, the first code 201c alone serves as a product-identifying code, and is associated with the product to be authenticated. The first code 201c may be any alphanumerical code, such as a serial number, generated to identify a product. The second code 202c is a much shorter code associated with the first code 201c and serves as a verification code.

The second code 202c is not required to be able to uniquely identify the first code 201c or the associated product and therefore can be significantly shorter than the first code 201c. In other words, there is no two-way unique correspondence between each second code 202c and a first code 201c or a product associated with the first code 201c. In particular, different first codes 201c (and correspondingly multiple products), even a great number of them, may happen to share the same verification code 202c. The numerical code 202c only needs to be long enough to create a substantial difficulty to guess when concealed. It is permissible that the second code 202c associated with several different first codes 201c of different product items may happen to have the same value and still able to offer an effective anti-counterfeiting effect. To be effective as an anti-counterfeiting measure, however, it is preferred that the second code 202c cannot be calculated or predicted from the first code 201c. One way to make the second code 202c unpredictable is to generate it as a random number.

The first code 201c and the second code 202c may be either generated and managed as parts of a single product code 200c, or separately generated and managed as two different codes associated with the same product. Separately generating the first code 201c may help avoiding redundancy of the first code 201c. The first code 201c independently serves as a product-identifying code which can be submitted for a verification or informational purpose. The two separately generated codes are used together subsequently for product authenticity verification, as shown below.

At Block 1S3, the manufacturer reproduces the first code (201c) and the second code (202c) on the product that can benefit from the anti-counterfeiting measure. When reproduced on the product, the first code is machine readable, and may or may not be also readable by human eyes. The machine readability may bring benefits such as automatic tracking and convenient code input and transmission. This can be done in a variety of ways on a variety of products. Any practical means that suits the manufacturer's requirements may be used. For example, the first code may be incorporated in a RFID tag which is attached to the product or the packaging of the product. The RFID tag may be readable by a special RFID reader, or a RFID reader incorporated into consumer product such as a smart phone. The RFID may be protected by a suitable encryption method. When reproduced on the product, the second code covert from normal viewing and is only conditionally revealed.

The product to be authenticated may be any kind of merchandise that potentially suffers the threat of counterfeiting. The examples include a drug, a branded liquor product, wine, cigarettes, clothes, food, supplements, a tool, a document, etc. The reproduction of the first code and the second code on the product may be done in any practical way. In general, however, the reproduced codes should preferably not be easily removed without causing a detectable damage or change to the reproduced product code and/or the product itself. If the product is contained in a packaging such as a box or a bottle, it is also generally preferred that the product contained in the packaging cannot be easily removed from the packaging without causing a detectable damage or change to the reproduced codes.

The second code may be printed on a separate label or tag of a suitable material and affixed to the product, but may also be printed or produced on the product itself if practical. In the present description, the term “product tag” may refer to any of these situations and does not necessarily suggest that physically separated or separable item. It is noted that reproducing a code on the product does not mean that the product is necessarily made first, and the code is reproduced on the product subsequently. The product and the reproduction of the code may be made in a single manufacturing process.

FIG. 3A-3B show an example of a first code and a second code reproduced on a product (the product is not shown). The first code 301c is contained in a RFID tag 301. In addition to the invisible electronic version of the first code 301c stored in a memory of the RFID tag, a visible copy or a barcode representation of the first code 301c may be optionally printed on an exterior surface of the RFID tag for additional purposes.

Alternatively, a separate code which is different from the first code 301c may be printed on an exterior surface of the RFID tag. The optional separate code may be an alphanumerical code readable by human eyes or a barcode readable by a barcode scanner. In such a combination, the RFID tag may be primarily used for tracking, while the visible separate code may serve as the products identification code and eased together with the second code for authentication.

The second code 302c is reproduced by printing on tag 302 which is attached to the product or a packaging containing the product. As illustrated in FIG. 3A, the second code 302c printed tag 302 is blocked from normal viewing using a concealment 332. Any suitable method may be used to accomplish such concealment. The goal is to cover the code 302c and make it invisible under normal conditions. At the same time, it is preferred that the concealment may be fairly easily removed for product authenticity check without requiring a special tool. To effectively guards against counterfeiting, the concealment should only be removable at least partially invasively, and once removed, should not be easily restored without leaving any visible marks to indicate that the concealment has once been removed to reveal the code 302c. The invasiveness at least partially damages or permanently alters the concealment such that it cannot be easily restored to its original condition.

One suitable method to achieve this goal is applying a scratch-off layer 332 to cover the second code 302c. The scratch-off layer 332 can be fairly easily scratched off without using a special tool to reveal the code 302c, and at the same time cannot be easily restored to cover the region again. An alternative is to use a layer of material that can be peeled off.

It is appreciated that the particular arrangement of the first code 301c and the second code 302c in FIG. 3A is only illustrative and not restrictive. For example, instead of using a tag 302 separated from the tag 301 to carry the second code 302c, the second code 302c may be printed on the same tag 301 which carries the first code 301c, or printed on a separate tag which is then attached to a surface of the tag 301 that carries the first code 301c. Furthermore, it is noted that the first code 301c and the second code 302c do not have to be reproduced in the same area, or the same tag, but can be reproduced at different areas or different parts and locations on the product or as part of a packaging of the product. Particularly, it is conceived that the first code 301c may be placed in an exterior part of the product or product packaging, while the second code 302c may be hidden in an area which is accessed only when the product packaging is opened. For example, the RFID tag 301 bearing the first code 301c may be affixed on an exterior surface of a box packaging, while the printed tag 302 bearing the second code 302c may be placed inside the box and accessible only after the box is opened. Alternatively, RFID tag 301 bearing the first code 301c may be affixed on an exterior surface of a bottle packaging, while the printed tag 302 bearing the second code 302c may be placed or printed on the inner surface of a cap or lid close in the bottle.

At Block 1S4, the verification center receives the first code 301c. This can be done using the special code reader, or a RFID reader built in a consumer device such as a smart phone. The first code 301c may be received without the second code 302c, or received together with the second code 302c after the second code has been revealed to an authorized person (such as a consumer).

At Block 1S5, the verification center checks the product codes stored therein to identify the second code associated with the received first code. Typically, the manufacturer or the anti-counterfeiting service provider has a data storage to keep a large number of article code records (product codes) that are associated with large number of products or product items.

At Block 1S6, the authenticity of the product is verified by matching the identified second code with the second code conditionally revealed from the article. This can be done in two different basic modes.

In the first mode, the authorized person sends the revealed second code 302c to the verification center, which then compares the received second code 302c with the second code identified at block 1S5. If a match is found between the two codes, the verification center sends a notification to the authorized person to indicate that the authenticity of the product has been verified. If not, a failure notification is sent. Alternatively, at Block 1S4, the verification center may receive the first code 301c only but not the second code 302c. Upon receiving the first code, the verification center checks against the product code records saved in the data storage to identify the second code associated with the first code, and sends a prompt to the authorized person to request for the second code 302c for verification.

In the second mode, the verification center sends the second code identified at block 1S5 to the authorized person such that the authorized person may compare the received second code with the second code 302c revealed on the product to determining the authenticity of the product. Specifically, at Block 1S4, the verification center may receive the first code 301c only but not the second code 302c. Upon receiving the first code, the verification center checks against the product code records saved in the data storage to identify the second code associated with the first code. The verification center then sends the identified second code to the authorized person, who then checks the received second code against the second code revealed on or in the product to determine if the two codes match. If the two codes do not match, it would indicate a counterfeit product. If they do match, it is an indicator that the product is likely to be genuine. This method essentially has an element to check not only the genuineness of the product, but also the legitimacy of the verification center, because it is possible that a counterfeit product may have provided information that guide the consumer to contact a bogus verification center which would always send out an affirmative answer for verification. However, this method also has a potential disadvantage as a counterfeiter might use the machine-readable code (the first code) to harvest the covert code (the second code). In addition, without the input of the covert code (the second code) from the consumer side, the verification center would also have a difficult time to keep a record of the number of times the product has been successfully verified as it would be difficult to determine whether each request of verification was a success or not. This alternate method, therefore, may be more useful if used for a subsequent or secondary verification in a design which has multiple covert codes for multiple verifications, as described below.

In the above described authentication process, the concealed second code 302c is conditionally revealed to an authorized person. The conditional revealing of the second code 302c requires physical access to the product. It also requires the concealment over the second code 302c to be at least partially invasively removed to uncover the concealed second code region 302 on the product. In the illustrated embodiment, the concealment is a scratch-off layer 332. As the authorized person gains physical access to the product, he may be allowed to manually remove the scratch-off layer 332 to reveal the second code 302c.

FIG. 3B shows an example of the product code after the concealment has been removed. In the illustrated embodiment, the concealment is a scratch-off layer 332. After the authorized person has removed the scratch-off layer 332, the code 302c is revealed.

The communication between the authorized person and the verification center may be carried out in a variety of ways, including a telephone by voice, a telephone to dial in numbers, a wireless phone using short messaging, a mobile application platform, and Internet-based user interface.

In a preferred embodiment, the verification center has a mobile communication center. The codes 301c and 302c are sent by the authorized person using a mobile device such as a cell phone to the verification center, which then returns the message of verification to the mobile device of the authorized person. This two-way communication may be done using simple text messaging such as SMS.

In another embodiment, the verification center is a call center which receives the codes from the authorized person over telephone. The codes may be provided either by voice or entered through a keypad on the telephone. Call-center may either have human operators or automatic voice processing.

The verification center may also send to the authorized person other information related to the product being verified at the time of verification. Examples of such information include prices, store locations, ratings of the product, coupons, or recommendation of related products.

To discourage counterfeiters from using real product codes recycled from used products, the verification center may keep records for the past verifications, and either reject a call for verification or send out a warning when the received product code has already been used for verification once or more in the past.

It is noted that in the above illustrated embodiment, each of the first code 301c and the second code 302c are processed as two separate codes associated with each other. The first code 301c independently serves as a product-identifying code which is submitted for product identification without combining with the second code 302c. This can be performed either before or after the concealment over the second code region 302 is removed to reveal the second code 302c. However, it is appreciated that the first code 301c and the second code 302c may be combined as a single code for product identification and authentication.

Even if the machine-readable first code 301c alone may not provide a high level of confidence for authenticity without combining with the covert code 302c, it may nevertheless be informative before the authorized person is committed to the product by removing the scratch-off 332. For example, suppose the first code 301c alone uniquely identifies the product at individual product item level in the system (which may or may not require mass serialization). Upon receiving from the authorized person the first code 301c to the verification center, the system may inform the authorized person whether this product has been verified before, and further how many times. If the system discovers that the particular product item has already been checked and verified by receiving from a previous authorized person both the first code 301c and the second code 302c, it may indicate a high likelihood that the particular product item is a counterfeit, and the authorized person (e.g., a consumer) would have learned this information before committing to the product and removing the concealment material over the covert code 302c.

However, if the system has no record of such verification in the past for this particular product item, the authorized person may desire a higher level of confirmation by committing to the product and to be allowed to reveal the covert code 302c. The higher level of confirmation may be desired because the mere “no record” status may not necessarily prove that the particular product item is genuine. It is possible that both a genuine product item and one or more counterfeit products bearing the identical first code 301c may exist in the market, and the genuine product item has not been sold yet. In this scenario, the product item checked by the authorized person could be either genuine or fake, and the authorized person will need to reveal the covert code 302c to further confirm.

In addition, the first code 301c may be separately used to obtain other product related information which may be helpful even without offering a high-level confidence of authenticity of the particular product item.

In another embodiment, the first code 301c may only offer to identify the product on other levels such as batch level, or product type level, instead of at an individual product item level. Such identification information may be used for purposes such as consumer assistance without requiring a commitment to the particular product item.

In one embodiment, the covert code 302c is substantially smaller than the product-identifying first code 301c. It is discovered that the amount of information that needs to be concealed from a potential counterfeiter to effectively discourage counterfeiting can be far less than the information that is required to sufficiently identify a product. Thanks to this asymmetric nature between the counterfeit-hampering information and the product-identifying information, only a relatively small part of the product code needs to be concealed as counterfeit-hampering covert code 302c.

In the example shown FIGS. 3A and 3B, the covert code 302c has only three digits. When these three digits are concealed from normal viewing and can only be invasively revealed, they create odds of one out of a thousand for a randomly guessed number to match the concealed covert code 302c. This means that if a would-be counterfeiter wants to statistically guarantee that at least one of its counterfeit products can pass the anti-counterfeiting verification, the counterfeiter will have to make a thousand such counterfeit products with all other nine hundred ninety nine facing rejection by the anti-counterfeiting verification. This creates a huge burden for counterfeiting and would make it unprofitable for counterfeiting virtually anything in the commerce. For ordinary products, even an odd of one out of ten created by a single-digit covert code may be a sufficient anti-counterfeiting measure. If alphabetical letters or other symbols are used in the product code instead of just numbers, the odds can be even smaller. For counterfeiters who are used to unrestrained and unburdened counterfeiting, this is already a dramatic increase of burden.

The discovery that only a small part of the product code needs to be concealed in order to hamper counterfeiting makes the anti-counterfeiting method of the present disclosure easy to implement and easy to practice. According to the prior art, removing the concealment of a long or large code can be a hassle for a consumer to do. Scratching off a covering of a long string of numbers, for example, is often not only time-consuming but also an unsightly and messy one. If a 2-D product code is used, it may result in even greater inconvenience and may prove to be too consumer-unfriendly to be implemented. With the anti-counterfeiting method disclosed herein, however, the code region that needs to be concealed may only occupy a fraction (e.g., less than one half, less than one quarter, or even smaller) of the area which is occupied by the product code as a whole. If the part of the product code that needs to be construed is alphanumerical, only one and up to six alphanumerical positions may provide an effective anti-counterfeiting measure.

It is noted that the effectiveness of the anti-counterfeiting method disclosed herein does not require a technological impossibility or even a real hardship for restoring the concealment. As long as the method makes it more difficult for a would-be counterfeiter to make counterfeit products, it has an anti-counterfeiting effect. When no anti-counterfeiting measure is implemented, a counterfeiter can freely make a counterfeit product with an arbitrary label that just visually appears similar to the product code of the manufacturer. When only a product-identifying code is used for anti-counterfeiting, the counterfeiter may be discouraged from using arbitrary product codes, but may still have relatively easy access to a large number of genuine product codes and use them to make counterfeit products which would have little problem with the anti-counterfeiting measure. In comparison, when at least a part of the product code is concealed, the counterfeiter will need to have real physical control over the product in order to gain access to the concealed product code. If the uncovering of the concealed code is further necessarily invasive to result in damaging or altering of the product code and/or the product, the counterfeiter would not only have to have physical control over the product, but will also run risk of rendering the real product unsellable in order to make a counterfeit product.

A machine-readable first code 301c further helps tracking the product in commerce. For example, one advantage of using RFID tags to bear the product-identifying first codes 301c is that such wireless tags make tracking much easier. Each node in the chain of shipment, such as a distributor and a retailer, may scan the product in bulk or individually and send the scanned results to a tracking center which is either a part of the product authentication verification center or connected thereto. In addition to serving regular purposes such as logistics, the tracking information may also further assist product authentication. For example, the verification center may send to the consumer extra information such as the purchase date of the identified product according to the tracking data during the process of checking the authenticity of a purchased product. If the indicated purchase date is much earlier than the actual time the consumer purchased the product that is being verified, the verification center may warn the consumer that the purchased product is likely not authentic despite its bearing of verifiable product codes. This is so because it is possible that a genuine product bearing the same product codes was purchased earlier but the buyer never contacted the verification center to check the authenticity of the product, and further the product codes (both the machine-readable first code and the covert second code) associated with that product have been subsequently acquired by a maker of counterfeiting product.

The data including the product-identifying first codes 301c stored in the RFID tag 301 may be protected by a desirable level of security. It is desirable that the RFID tag is protected from unauthorized writing over the existing data in order to prevent data loss or intentional sabotage. To further reinforce such protection, either an overt copy of the same first code 301c or a different code which is capable of equivalently identifying the same product may be printed on an exterior surface of the RFID tag 301, or printed in a different area on the same product.

However, due to the use of covert code 302c, the need to keep the secrecy of the machine-readable code 301c is much lessened. In fact, even if a counterfeiter acquires the machine-readable code 301c, it is not economical to make a counterfeiting product without knowing the covert code 302c. Without stringent requirement for secrecy, the first code 301c may be made readable by mass-produced consumer products such as smart phones. This makes the disclosed anticounterfeiting method much easier to implement as it does not require the retailer to buy a special reader, and also does not require a formal participation of the retailer in the process of the product authentication. In addition, the consumer only needs to trust a centralized authentication verification center, rather than each individual retailer.

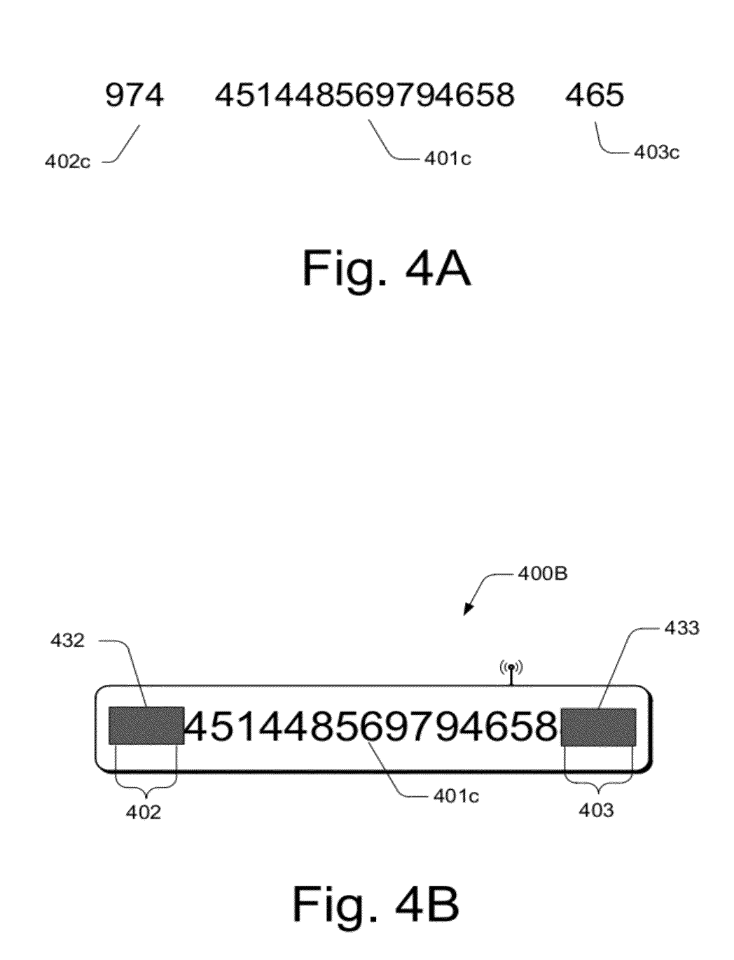

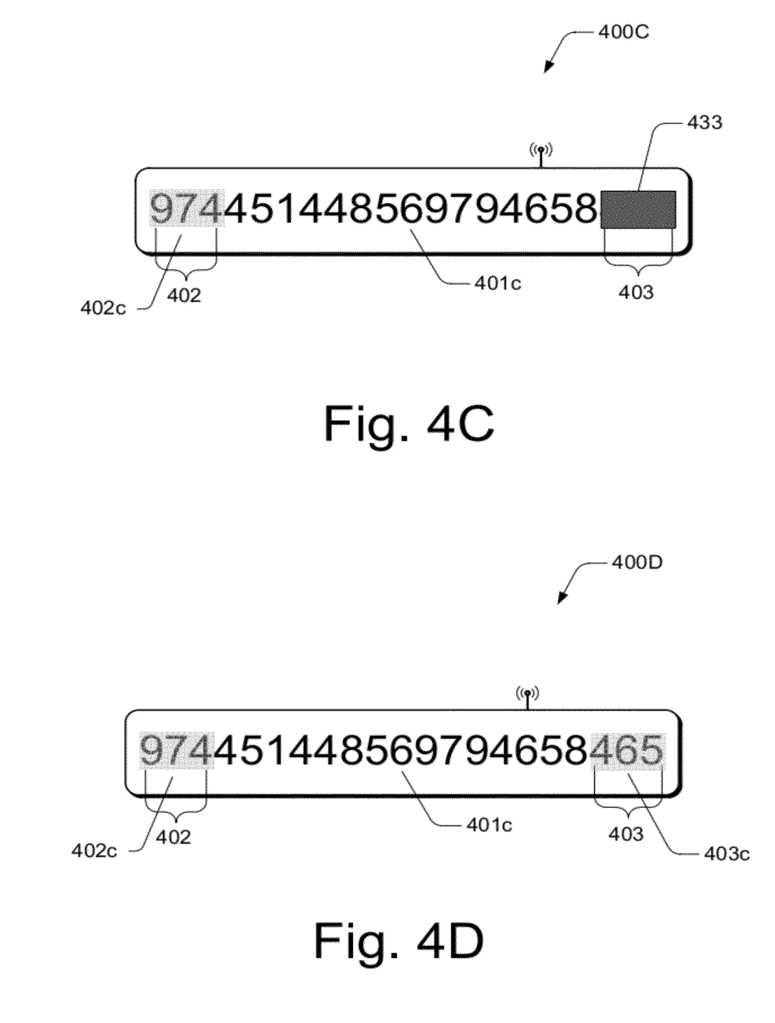

A second exemplary embodiment of the disclosed anti-counterfeiting method is illustrated in reference to FIG. 4 and FIGS. 4A, 4B, 4C and 4D.

FIG. 4 shows a flow process of the second exemplary embodiment of the anti-counterfeiting method. The second exemplary embodiment differs from the first exemplary embodiment in that here the product has two covert codes instead of just one.

At Block 4S1, the manufacturer associates a first code with a product, and further associates a second code and a third code would the first code.

FIG. 4A shows an exemplary first code, second code and third code used in the second exemplary embodiment of the anti-counterfeiting method. The first code 401c, the second code 402c, and the third code 403c are all simple numerical codes for the purpose of illustration. In one embodiment, the first code 401c is capable of identifying a product with a sufficient level of specificity (e.g., at individual product item level), and may alone be used as a product-identifying code associated with the product. Correspondingly, the second code 402c and the third code 403c can be small or short codes each serving as a challenging code to verify the product-identifying code 401c. The first code 401c may be generated separately from the second code 402c and the third code 403c. The second code 402c and the third code 403c maybe random numbers assigned to the first coat 401c.

At Block 4S2, the manufacturer stores the first, the second and the third codes 401c, 402c, 403c in a data storage (not shown).

At Block 4S3, the manufacturer reproduces the product code on the product that can benefit from the anti-counterfeiting measure.

At Block 4S4, the manufacturer conceals the second code 402c and the third code 403c on the product.

FIG. 4B shows an exemplary reproduction of the product codes according to the second exemplary embodiment. The first code 401c, the second code 402c, and the third code 403c are all reproduced on tag 400B, which, as illustrated, is a RFID tag. The first code 401c is digitally stored in a memory of the RFID tag 400B and is readable wirelessly by a RFID reader (not shown). Optionally, an additional copy of the first code 401c is visibly reproduced on the surface of the RFID in either plain human-readable form or machine-readable barcodes.

The second code 402c and the third code 403c are each printed on an end of the RFID 400B but concealed from normal viewing. It is appreciated that the second code 402c and the third code 403c may alternatively each be printed on a separate tag and placed at a different location on the same product.

As illustrated, the second code region 402 and the third code region 403 are concealed from normal viewing by a scratch-off layer 432 and a scratch-layer 433 respectively. The scratch-off layers 432 and 433 can be fairly easily scratched off to reveal the second code 402c and the third code 403c, and at the same time not easily restored to cover the region again. As shown, the concealed regions 402 and 403 are preferably separated from each other in order to be clearly viewed as two separate sections serving different purposes. As will be shown below, each concealed region can be used for a separate occasion for verification by a different person.

At Block 4S5, one of the concealed code 402c and 403c is conditionally revealed to an authorized person. FIG. 4C shows an example of the product tag 400C with one of the covert codes revealed. After the authorized person has removed the scratch-off layer 432, the code 402c in the second code region 402 is revealed. Alternatively, the authorized person may remove the scratch-off layer 433 at this step to reveal the third code 403c.

At Block 4S6, a product authentication verification center receives the first code 401c and the revealed second code 402c. The verification center may either receive first code 401c and the revealed second code 402c together from the same authorized person (e.g. a customer who just purchased the product), or receive the first code 401c from a special reader such as one operated by a retailer first, and then receive the second code 402c from the customer to whom the second code 402c has just been revealed.

At Block 4S7, the verification center compares the received first code 401c and the second code 402c with the product code stored in the data storage for a possible match. The match can be either done for the combined code 412c as a single code, or separately for each of the first code 401c and the second code 402c.

At Block 4S8, the verification center verifies to the authorized person that the product is authentic if the received first code 401c and the second code 402c match the product codes stored in the data storage. At this stage, for example, because the authorized person may have scratched off any one of the two concealed code areas 402 and 403, a search at the data storage where the product codes are stored may match the first code 401c with the first code in the stored product code, and match the received second code 402c with any one of the second code and the third code in the stored product code. These stored codes (the first code, the second code and the third code) may be kept as separate records but are associated with the same product, or kept as different data segments of a single record. The storage scheme may affect the search scheme, but any suitable method may be used and the manner of data storage and search is not an essence of the present disclosure.

As discussed in the first exemplary embodiment in FIG. 1, in an alternative embodiment, the verification center may receive the first code 401c only, identify the second code associated with the received first code 401c, and send the identified second code to the customer to be compared with the second code revealed on the product to the customer for verification. This method helps to check the legitimacy of the verification center.

In addition, the first code 401c, which alone serves as a product-identifying code, may be submitted for a verification or informational purpose without revealing and/or combining with one of the second code 402c and the third code 403c. This can be performed before the concealment over the second code region 402 is removed to reveal the second code 402c. Subsequently, the authorized person may desire a higher level of confirmation by committing to the product and to be allowed to reveal one of the covert codes 402c and 403c.

FIG. 4D shows an example where the third code 403c is used for a second verification opportunity. After the first authorized person (e.g., a consumer) has done verification, one of the two concealed code regions 402 and 403 still remains concealed and may be used to offer a second opportunity for product authenticity verification. In the present case, the third code region 403 remains concealed as shown in FIG. 4C.

A second authorized person (e.g., a second consumer) may remove the scratch-off layer 433 to reveal the third code 403c for product authenticity verification in a manner similar to how the first authorized person has done using the second code 402c.

Alternatively, in the second verification, the verification center may receive the first code 401c only (or the first code 401c and the second code 402c only) but not the third code 403c. Upon receiving the first code (or the first code and the second code), the verification center checks against the product code records saved in the data storage to identify the code record associated with the product identified by the first code. The verification center then sends the third code associated with the identified first code back to the second authorized person, who then checks the received third code against the third code revealed on or in the product to determine if the two codes match. This method helps to check the legitimacy of the verification center. In addition, because the second verification happens only after the first authorized person has already checked the authenticity of the product using the one of the covert codes (i.e., the second code), it prevents a counterfeiter from using a bogus procedure for the second verification to fish for covert codes of the product.

The second chance for verification described above may be useful in occasions where there is a return by the first authorized person and a subsequent authorized person who buys the returned product may still have a separate opportunity to verify the authenticity of the product. In addition, the revealed status of the first covert code also provides evidence that the product is a return, and the subsequent authorized person may only want to buy it with a discount. This therefore also provides a protection to consumers from unknowingly buying returned products. The second verification chance may also be useful when the product is bought by the first consumer who performed the verification at the retail place, and subsequently gives the product to another person as a gift. In this case, the recipient of the gift would have an independent chance to verify the authenticity of the product.

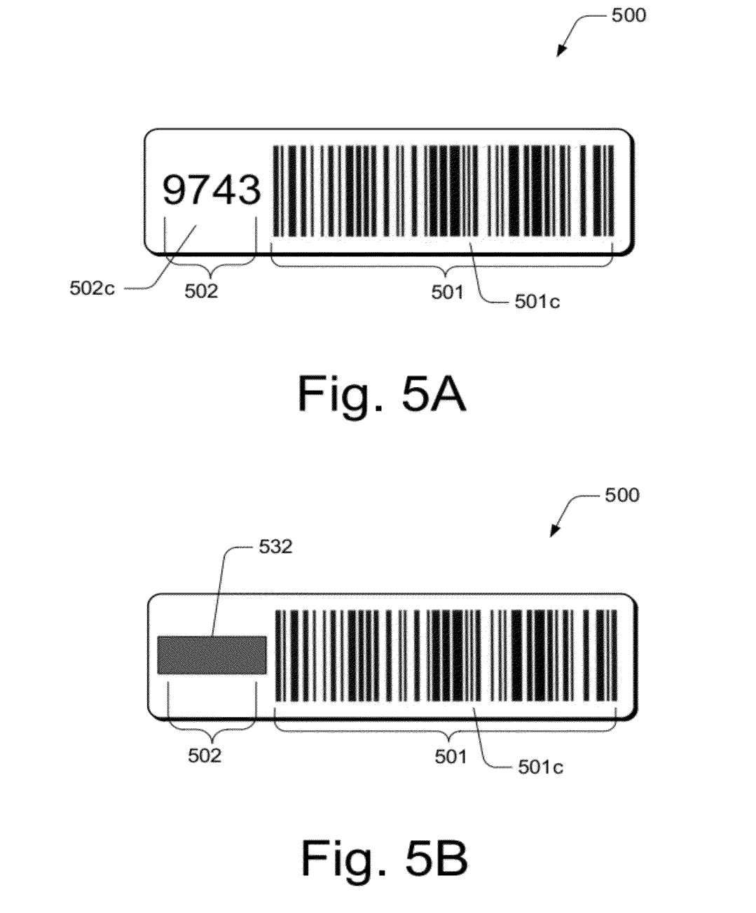

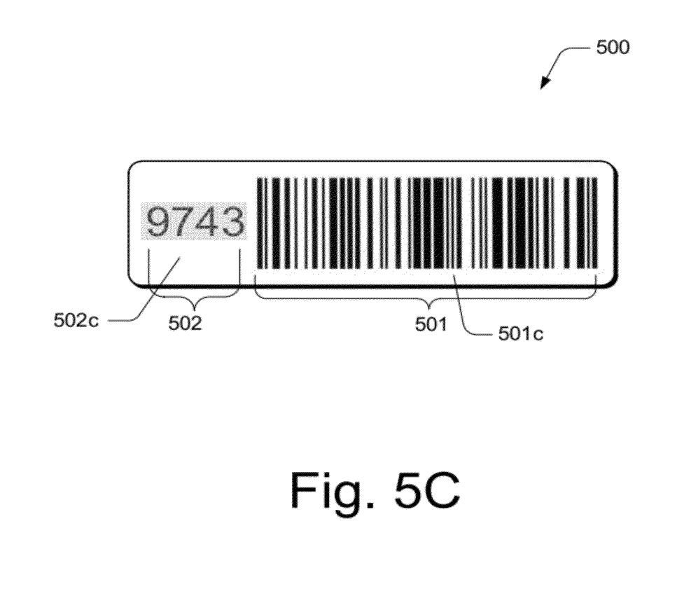

FIGS. 5A-6C show an exemplary anticounterfeiting code using a mix of a machine-readable barcode and an alphanumerical verification code. Except for the information coding scheme, the anti-counterfeiting method using a machine-readable barcode code is largely similar to that using a RFID tag as shown herein.

The mixed code tag 500 has a barcode 501c at the first code area 501, and a plain numeric code 502c in the second code area 502. The numeric code 502c is to be concealed. The barcode 501c can be read using a barcode scanner. The barcode 501c can be a typical barcode code containing encoded information.

FIG. 5B shows the mixed code tag 500 as reproduced on the product to be authenticated, where the numeric code 502c in the second code area 502 is concealed using a concealment (e.g., scratch-off material) 532. The barcode 501c is still uncovered and can be read using a barcode scanner.

FIG. 5C shows the mixed code 500 with the concealment 532 removed to reveal the numeric code 502c.

In the above embodiment, the barcode 501c alone may be used to identify the product. The level of identification may have a desired specificity such as an individual product item level. It can be used for product-identification purposes or even a limited anti-counterfeiting purpose even without the help of the additional numerical code 502c. The numerical code 502c is added to serve as a verification code to verify the product-identifying barcode 501c. The numerical code 502c is not generated to identify the product and therefore does not need to be a very long code. It only needs to be long enough to create a difficulty to guess when concealed. When a verification system receives both the barcode 501c and the numerical code 502c, it may first use the barcode 501c to identify the product, and then use the product code record stored to check whether the received verification code 502c is correct. Ideally, only a specific number of verification codes are associated with each product-identifying code (barcode 501c) to offer certainty. For example, in the illustrated embodiment, the numeric code 502c may be the only verification code associated with the barcode 501c and accepted to verify it. As discussed herein, even a very short alphanumerical code may effectively discourage would-be counterfeiters from making counterfeit products even if they have knowledge of the product-identifying machine-readable first code 501c.

The machine-readable code and the covert code(s) may be placed (e.g. printed) on the same layer of material, while the covert code(s) is covered by a separate layer of concealment material. However, it is noted that this type of implementation is only illustrative and not restrictive. In one embodiment, a product tag may have a machine-readable code placed on a first layer of a code-bearing medium, and one or more covert codes placed on a second or third layer of code-bearing medium. The various layers of code-bearing medium may or may not be made of the same material. In this arrangement, instead of using a separate concealment material such as a scratch-off layer, at least a part of the first layer of code-bearing medium may be used as a means to cover the second or the third layer of code-bearing medium to conceal the covert code(s).

Furthermore, in the illustrated embodiments, the machine-readable code and the covert code(s) are placed in different code regions and physically separated from each other. However, it is noted that this is only illustrative and not restrictive. It is possible to place both the machine-readable code and the covert code(s) in the same area overlapping with each other, but readable by different means. As long as the following condition is satisfied, the anti-counterfeiting method described herein can be made effective: the covert code(s) cannot be easily revealed and reproduced on another product by an unauthorized party.

Exemplary embodiments are employed to illustrate the concept and implementation of the present invention in this disclosure. The exemplary embodiments are only used for better understanding of the method and core concepts of the present invention. Based on the concepts in this disclosure, a technician of ordinary skills in the art may make some modifications. These modifications should also be under the scope of the present invention.

1. An anti-counterfeiting method comprising:
associating a first code with an article, the first code being designed to identify an article at a desired level of specificity;
associating a second code with the first code, the second code acting as a verification code to verify the first code;
reproducing the first code on or in the article such that the first code is machine-readable;
reproducing the second code on or in the article such that the second code is covert from normal viewing and is only conditionally revealed;
receiving the first code at a verification center;
identifying the second code associated with the received first code; and
allowing matching the identified second code with the second code conditionally revealed from the article for verifying the article's authenticity.

2. The anticounterfeiting method of claim 1, wherein reproducing the first coat on the article comprises:
incorporating the first code with a RFID tag; and
attaching the RFID onto the article.

3. The anticounterfeiting method of claim 1, wherein allowing matching the identified second code with the second code conditionally revealed from the article comprises:
receiving the second code at a verification center after the second code has been revealed to an authorized person;
matching the received second code and the second code found in the article code records in association with the first code; and
sending a verification result to the authorized person.

4. The anticounterfeiting method of claim 1, wherein allowing matching the identified second code with the second code conditionally revealed from the article comprises:
sending the second code found in the article code records in association with the first code in response to receiving the first code such that an authorized person may compare the received second code with the second code revealed to the authorized person.

5. The anti-counterfeiting method of claim 1, wherein the second code reproduced on the article is covered by a layer of removable material.

6. The anti-counterfeiting method of claim 1, wherein the second code cannot be revealed to be reproduced on another article by an unauthorized party without performing an invasive act on the article.

7. The anti-counterfeiting method of claim 1, wherein the second code is significantly shorter than the first code and does not uniquely identify the article.

8. The anti-counterfeiting method of claim 1, wherein the second code is alphanumerical code having less than or equal to six alphanumerical positions.

9. The anti-counterfeiting method of claim 1, wherein the second code is a random number assigned to the first code.

10. The anti-counterfeiting method of claim 1, wherein reproducing the second code on or in the article comprises reproducing the second code on a tag affixed onto the article.

11. The anti-counterfeiting method of claim 1, wherein reproducing the second code on or in the article comprises reproducing the second code directly onto or in the article.

12. The anti-counterfeiting method of claim 1, wherein the article on which the first code and the second code are reproduced comprises a container containing goods therein.

13. The anti-counterfeiting method of claim 1, wherein the first code is received wirelessly from a code reader.

14. The anti-counterfeiting method of claim 1, wherein the second code is received from a telephone by voice or through a keyboard.

15. The anti-counterfeiting method of claim 1, wherein the second code is received through a mobile application user interface.

16. The anti-counterfeiting method of claim 1, further comprising:
associating a third code with the first code as an alternate verification code to verify the first code;
reproducing the third code on or in the article, the third code being covert from normal viewing and is only conditionally revealed;
identifying the third code associated with the received first code; and
allowing matching the identified third code with the third code conditionally revealed from the article for verifying the article's authenticity.

17. The anti-counterfeiting method of claim 16, wherein, when reproduced on the article, the second code and the third code are clearly separated from each other.

18. The anti-counterfeiting method of claim 1, further comprising:
reproducing a second copy of the first code on or in the article, the second copy of the first code being overt to normal viewing.

19. The anti-counterfeiting method of claim 1, further comprising:
identifying the article associated with the received first code at the verification center; and
sending information related to the identified article to an authorized person.

20. An anti-counterfeiting method comprising:
associating a first code with an article, the first code being able to identify the article at a desired level of specificity;
associating a second code with the first code as a verification code to verify the first code;
reproducing the first code and the second code on or in the article, the first code being machine readable, and the second code being covert from normal viewing and is only conditionally revealed;
receiving the first code at a verification center;
receiving the second code at a verification center after the second code has been revealed to an authorized person;
verifying the association between the received first code and the second code; and
notifying the authorized person of a verification result.

21. The anticounterfeiting method of claim 20, wherein reproducing the first coat on the article comprises:
incorporating the first code with a RFID tag; and
attaching the RFID onto the article.

22. The anti-counterfeiting method of claim 20, wherein notifying the authorized person of a verification result comprises sending a text message to a mobile device of the authorized person.

23. An anti-counterfeiting product packaging, the packaging comprising:
a RFID tag containing a first code which uniquely identifies a product associated with the packaging; and
a second code concealed from normal viewing by a concealment which is invasively removable to reveal the second code and once removed cannot be easily restored to its original status, wherein the second code is associated with the first code as a verification code to verify the first code.

24. The product packaging of claim 23, wherein the second code is an alphanumerical code having one to six alphanumerical positions.

25. The product packaging of claim 23, further comprising:
a third code concealed from normal viewing by a second concealment which is invasively removable to reveal the third code and once removed cannot be easily restored to its original status, wherein the third code is associated with the first code as an alternate verification code to verify the first code.

26. The product packaging of claim 25, wherein the second code and the third code are clearly separated from each other.

27. The product packaging of claim 23, further comprising:
a printed copy of the first code overt to normal viewing.
